(19) United States
(12) Patent Application Publication
(10) Pub. No.: US 2020/0076938 A1
(43) Pub. Date: Mar. 5, 2020

(54) METHOD AND SYSTEM FOR MANAGING ACCESSORY APPLICATION OF ACCESSORY DEVICE BY COMPANION DEVICE

(71) Applicant: SAMSUNG ELECTRONICS CO., LTD., Suwon-si, Gyeonggi-do (KR)

(72) Inventor: Pulkit AGRAWAL, Aligarh (IN)

(73) Assignee: Samsung Electronics Co., Ltd., Suwon-si, Gyeonggi-do (KR)

(21) Appl. No.: 16/346,731

(22) PCT Filed: Jan. 9, 2018
(86) PCT No.: PCT/KR2018/000448

§ 371 Date: May 1, 2019

(30) Foreign Application Priority Data
Jan. 9, 2017 (IN) 201741000790

(51) Int. Cl. H04M 1/725; G06F 1/16; H04W 4/80; H04M 1/60

(52) U.S. Cl. CPC H04M 1/7253; G06F 1/163; H04M 1/72533; H04M 1/6066; H04W 4/80

(57) ABSTRACT

Embodiments herein provide a method and electronic device for managing accessory application of accessory device by companion device. The method includes identifying the at least one pre-determined feature of the accessory application running at the accessory device. Further, the method includes generating the application package comprising the at least one component of the at least one pre-determined feature of the accessory application and transferring the application package to a companion device to perform at least one operation corresponding to the at least one pre-determined feature of the accessory application at the companion device on behalf of the accessory device.

### CROSS-REFERENCE TO RELATED APPLICATION(S)

This application is a National Phase Entry of PCT International Application No. PCT/KR2018/000448, which was filed on Jan. 9, 2018, and claims priority to Indian Patent Application No. 201741000790, which was filed on Jan. 9, 2017, the contents of which are incorporated herein by reference.

### TECHNICAL FIELD

The embodiments herein generally relate to electronic devices. More particularly to a method and system for managing an accessory application of an accessory device by a companion device.

### BACKGROUND

With the advance of hardware and communication technologies, the interaction between electronic devices and wearable devices is exploding rapidly. The electronic devices i.e., mobile device such as smart phone, Personal Digital Assistants (PDA), and wearable devices such as, for e.g., smart watch, smart band, etc. In current wearable device scenarios, the wearable device acts as slave to the smart phone i.e., mere displaying of notification(s) and quick prompt handler by the wearable device.

The notifications which are received by the smart phone can swiftly appear on the smart watch there from a user can quickly reply to the notification received. The operation(s) such as displaying one or more notifications is redundant in both the smart phone and the smart watch, forwarding, by the smart phone, the notification to the wearable device thereof consumes precious central processing unit (CPU) cycles of the smart phone by first transferring the notification and secondly displaying the same. This CPU cycles can suppress battery level and memory capacity of the smart phone.

FIG. 1A illustrates an example scenario in which a normal application calling is detailed. Referring to the FIG. 1A, an accessory device 100 (i.e., smart phone) may include one or more applications (application A, B . . . N) installed therein. Each application may include an application logic providing one or more instructions to perform the operations (i.e., invoking, calling, etc., as defined by the application vendor) respectfully. Further the each application is composed of, for example, three types of features i.e., interactive features, non-interactive features, and bounded feature (not shown). Whenever, the accessory device 100 fetches a notification corresponding to any application (application A, B . . . N), the application logic can identify the type of feature, from the aforementioned features, to be called/invoked in accordance with the notification received.

### SUMMARY

Further, when the accessory device 100 is connected/paired with a wearable device 200, the accessory device 100 merely forwards the notifications fetched to the wearable device 200. The mechanism by which the accessory device 100 can conserve the precious CPU cycles and further leveraging the resources of the wearable device 200 thereto remains unexplored.

The above information is presented as background information only to help the reader to understand the present invention. Applicants have made no determination and make no assertion as to whether any of the above might be applicable as Prior Art with regard to the present application.

The principal object of the embodiments herein is to provide a method and system for managing an accessory application of an accessory device by a companion device.

Another object of the embodiments herein is to provide a method for receiving, by the accessory device, an input on an indication of the accessory application displayed on the accessory device and enabling, by the accessory device, a companion mode for the accessory application based on the input, wherein the companion mode is configured to provide an application package comprising at least one component of the at least one pre-determined feature of the accessory application.

Another object of the embodiments herein is to provide a method for receiving, by the companion device, a notification intended for an accessory application at an accessory device, determining, by the companion device, whether the notification corresponds to at least one pre-determined feature of the accessory application and performing, by the companion device, at least one operation corresponding to the at least one pre-determined feature of the accessory application using a companion application at the companion device on behalf of the accessory device.

Another object of the embodiments herein is to provide a method for identifying, by a server, at least one pre-determined feature of the accessory application running at the accessory device, generating, by the server, an application package comprising at least one component of the at least one pre-determined feature of the accessory application and transferring, by the server, the application package to the companion device to perform at least one operation corresponding to the at least one pre-determined feature of the accessory application at the companion device on behalf of the accessory device.

Another object of the embodiments herein is to utilize, by way of the proposed method, the computing capabilities of the accessory device and providing the additional resource to the companion device paired with the accessory device, by running the features of non-user triggering dependent processes in the companion device context.

Another object of the embodiments herein is to increase, by way of the proposed method, the device longevity and the performance by summing up the capabilities of both the accessory device and the companion device.

Accordingly the embodiments herein provide a method for managing an accessory application of an accessory device by a companion device. The method includes receiving, by the accessory device, a input on an indication of the accessory application displayed on the accessory device and enabling, by the accessory device, a companion mode for the accessory application based on the input, wherein the companion mode is configured to provide an application package comprising at least one component of the at least one pre-determined feature of the accessory application.

In an embodiment, the at least one component of the at least one pre-determined feature is configured to provide a companion application to perform at least one operation corresponding to the at least one pre-determined feature of the accessory application.

In an embodiment, the method further comprises: identifying the at least one pre-determined feature of the accessory application running at the accessory device, generating, by the accessory device, the application package comprising the at least one component of the at least one pre-determined feature of the accessory application, and transferring, by the accessory device, the application package to a companion device to perform at least one operation corresponding to the at least one pre-determined feature of the accessory application at the companion device on behalf of the accessory device.

In an embodiment, the indication of the accessory application is dynamically modified after adding the accessory application in the companion mode, wherein the modified indication of the accessory application indicates the availability of the accessory application in the companion mode.

In an embodiment, the companion device is selected by the accessory device based on a qualification index.

In an embodiment, the qualification index is dynamically updated based on a plurality of parameters associated with the companion device, wherein the parameters comprises at least one of a synchronization event, a storage capacity, device capability, battery level, and resources availability.

In an embodiment, the method further includes receiving information about the at least one operation corresponding to the at least one pre-determined features of the accessory application performed on the companion device based on a synchronization event.

Accordingly the embodiments herein provide a method for managing an accessory application of an accessory device by a companion device. The method includes receiving, by the companion device, a notification intended for an accessory application at an accessory device. Further, the method includes determining, by the companion device, whether the notification corresponds to at least one pre-determined feature of the accessory application and performing, by the companion device, at least one operation corresponding to the at least one pre-determined feature of the accessory application using a companion application at the companion device on behalf of the accessory device.

In an embodiment, the companion application is created by receiving an application package comprising at least one component of the at least one pre-determined feature of the accessory application, wherein the at least one components of the at least one pre-determined feature are configured to provide a companion application to perform at least one operation corresponding to the at least one pre-determined feature of the accessory application, and creating the companion application based on the application package.

In an embodiment, the method further comprises sending information about the at least one operation, corresponding to the at least one pre-determined features of the accessory application, performed on the companion device based on a synchronization event

In an embodiment, the companion mode is created based on at least one input preformed on an indication of the accessory application.

Accordingly the embodiments herein provide a method for managing an accessory application. The method includes identifying, by a server, at least one pre-determined feature of the accessory application running at the accessory device. Further, the method includes generating, by the server, an application package comprising at least one component of the at least one pre-determined feature of the accessory application and transferring, by the server, the application package to the companion device to perform at least one operation corresponding to the at least one pre-determined feature of the accessory application at the companion device on behalf of the accessory device.

In an embodiment, the identifying of the at least one pre-determined feature of the accessory application running at the accessory comprises: determining whether a companion mode is enabled for the accessory application, and identifying the at least one pre-determined feature of the accessory application in response to determining that the accessory application is available in the companion mode.

Accordingly the embodiments herein provide a server. The server includes a memory, a processor, and a companion manager (CM), coupled to the memory and the processor, configured to: identify at least one pre-determined feature of an accessory application running at the accessory device, generate an application package comprising at least one component of the at least one pre-determined feature of the accessory application, and transfer the application package to a companion device to perform at least one operation corresponding to the at least one pre-determined feature of the accessory application at the companion device on behalf of the accessory device.

Accordingly the embodiments herein provide a companion device. The companion device includes a memory, a processor, and a companion manager (CM), coupled to the memory and the processor, configured to: receive a notification intended for an accessory application at an accessory device, determine whether the notification corresponds to at least one pre-determined feature of the accessory application, and perform at least one operation corresponding to the at least one pre-determined feature of the accessory application using a companion application at the companion device on behalf of the accessory device.

According to another embodiments herein provide an accessory device. The accessory device includes a memory, a processor, and a companion manager (CM), coupled to the memory and the processor, configured to: receive a input on an indication of an accessory application displayed on the accessory device, and enabling a companion mode for the accessory application based on the input, wherein the companion mode is configured to provide an application package comprising at least one component of the at least one pre-determined feature of the accessory application.

Accordingly the embodiments herein provide a system for managing an accessory application. The system comprises an accessory device configured to: receive a input on an indication of an accessory application displayed on the accessory device, and enabling a companion mode for the accessory application based on the input, wherein the companion mode is configured to provide an application package comprising at least one component of the at least one pre-determined feature of the accessory application. Further, the system includes the companion device configured to: receive a notification intended for the accessory application at the accessory device, determine whether the notification corresponds to the at least one pre-determined feature of the accessory application, and perform at least one operation corresponding to the at least one pre-determined feature of the accessory application using a companion application at the companion device on behalf of the accessory device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This invention is illustrated in the accompanying drawings, throughout which like reference letters indicate corresponding parts in the various figures. The embodiments herein will be better understood from the following description with reference to the drawings, in which:

FIG. 1A illustrates an example scenario in which a normal application calling is detailed, according to prior art;

FIG. 1B is an example scenario in which a companion mode application calling scenario between an accessory device and a companion device is detailed, according to an embodiment as disclosed herein;

FIG. 1C is an example scenario in which a companion mode application calling scenario between an accessory device, server, and a companion device is detailed, according to another embodiment as disclosed herein;

FIG. 2A illustrates another example scenario in which the operations between a smart phone and a wearable device are detailed, according to prior art;

FIG. 2B illustrates another example scenario in which the operations between an accessory device and a companion device are detailed, according to an embodiment as disclosed herein;

FIG. 3A illustrates an example scenario illustrating a communication between an accessory device and paired audio earphone, according to prior art;

FIG. 3B is an example scenario illustrating a communication between an accessory device, paired audio earphone, and a wearable device (i.e., companion device), according to an embodiment as disclosed herein;

FIG. 4 illustrates various units of an accessory device for managing an accessory application, according to an embodiment as disclosed herein;

FIG. 5 illustrates various units of a companion device for managing an accessory application, according to an embodiment as disclosed herein;

FIG. 6 illustrates various units of a server for managing an accessory application, according to an embodiment as disclosed herein;

FIG. 7 illustrates an architecture for managing an accessory application of an accessory device by a companion device, according to an embodiment as disclosed herein;

FIG. 8A illustrates a state of a processor of: an accessory device and a companion device, for managing the one or more accessory applications, according to prior art;

FIG. 8B illustrates a state of a processor of: an accessory device and a companion device, for managing the one or more accessory applications, according to an embodiment as disclosed herein;

FIG. 9A illustrates an example scenario in which an accessory device is configured to manage one or more features of a video player application running at the accessory device, according to prior art;

FIG. 9B illustrates an example scenario in which an accessory device is configured to manage one or more features of a video player application running at the accessory device, according to an embodiment as disclosed herein;

FIG. 10A illustrates an example scenario in which an accessory device is configured to manage one or more features of a clock calendar application running at the accessory device, according to prior art;

FIG. 10B illustrates an example scenario in which an accessory device is configured to manage one or more features of clock calendar application running at the accessory device, according to an embodiment as disclosed herein;

FIG. 11A illustrates an example scenario in which normal operation mode of the at least one feature of the at least one application is disclosed, according to prior art;

FIG. 11B illustrates an example in which companion mode operation of at least one feature of at least one application is disclosed, according to prior art;

FIG. 12 is a flow diagram illustrating a method for managing the accessory application of the accessory device, according to an embodiment as disclosed herein;

FIG. 13 illustrates an example scenario in which the user of the accessory device associates and de-associates the at least one accessory application from the companion mode, according to an embodiment as disclosed herein;

FIG. 14 is an example in which an indication of the accessory application is modified, according to an embodiment as disclosed herein

FIG. 15 is another flow diagram illustrating a method for managing an accessory application of an accessory device by a companion device, according to an embodiment as disclosed herein;

FIG. 16 is a flow diagram illustrating a method for managing an accessory application of an accessory device by a server, according to an embodiment as disclosed herein;

FIG. 17 illustrates an example scenario in which the at least one operation of a non-interactive of an accessory application (i.e., SNS application) is managed by a companion device, according to an embodiment as disclosed herein;

FIG. 18 is a flow diagram illustrating a complete process flow between an accessory device and a companion device for managing an accessory application, according to an embodiment as disclosed herein;

FIG. 19 is a flow diagram illustrating a complete process flow between an accessory device and a companion device for managing the accessory application, according to an embodiment as disclosed herein; and

FIG. 20 illustrates a computing environment implementing the method for managing the accessory application, according to embodiments as disclosed herein.

### DETAILED DESCRIPTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiments, each application is composed of, for example, three types of features i.e., first feature, second feature and third feature. The first feature, second feature and third feature can be classified by a predetermined condition. For example, the predetermined condition is whether a certain feature is suitable for being displayed on a wearable device or not. Accordingly the embodiments, the first feature comprises interactive feature or user triggering dependent feature. The second feature comprises non-interactive feature, non-user triggering dependent feature or limited user interaction. The third comprises bounded feature.

Accordingly the embodiments herein provide a method for managing an accessory application of an accessory device by a companion device. The method includes receiving, by the companion device, a notification intended for an accessory application at an accessory device. Further, the method includes determining, by the companion device, whether the notification corresponds to at least one non-user triggering dependent feature of the accessory application and performing, by the companion device, at least one operation corresponding to the at least one non-user triggering dependent feature of the accessory application using a companion application at the companion device on behalf of the accessory device.

Accordingly the embodiments herein provide a method for managing an accessory application of an accessory device by a companion device. The method includes receiving, by the accessory device, a input on an indication of the accessory application displayed on the accessory device and enabling, by the accessory device, a companion mode for the accessory application based on the input, wherein the companion mode is configured to provide an application package comprising at least one component of the at least one non-user triggering dependent feature of the accessory application.

Unlike conventional methods and system, the companion manager (CM) of the proposed method may delegate at least one operation of the at least non-user triggering dependent feature of the accessory application to the companion device.

Unlike conventional methods and system, the companion manager, of the proposed invention, circumvents the redundant operations performed by both the accessory device and the companion device. Thus, by virtue of the companion manager; the battery level of the accessory device can be extended and further increasing the performance of the accessory device by conserving the processor cycle of the smart phone.

Unlike conventional methods and systems, the proposed methods and systems can allow the wearable device to act as Pseudo Host (Master) instead of slave, to the Smartphone (Actual Host of features) and can run the smart phone Non-Interactive (Non-user triggering dependent feature) features (for which there is no interactive process associated.

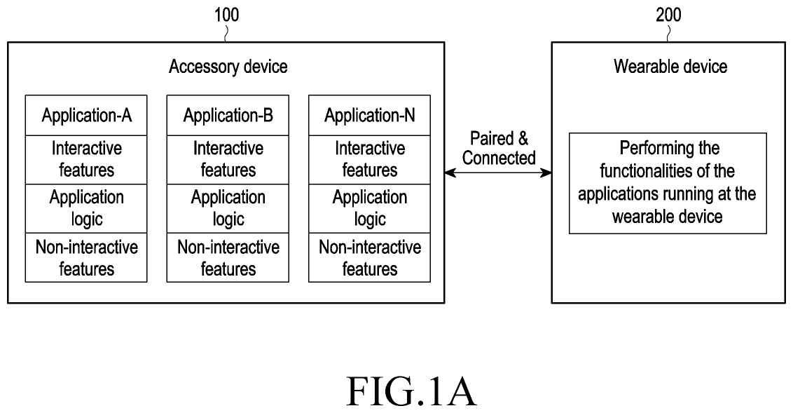

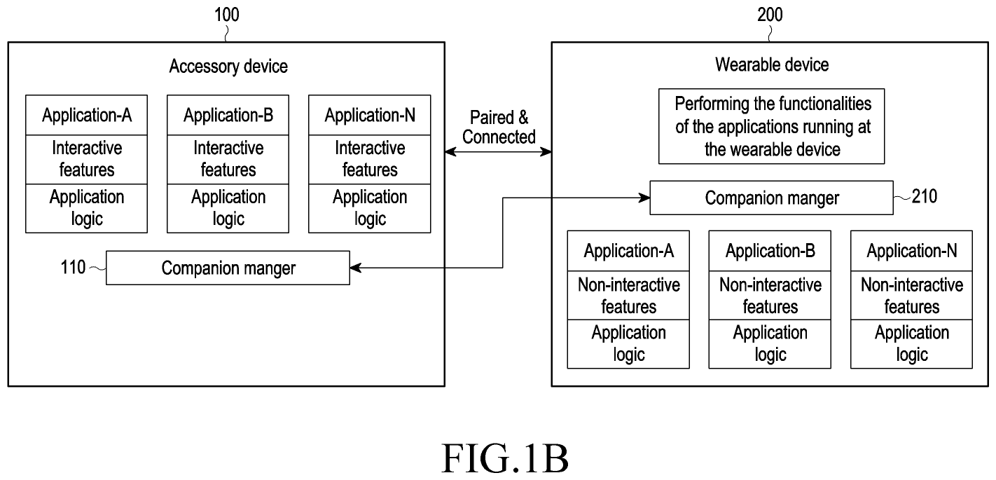

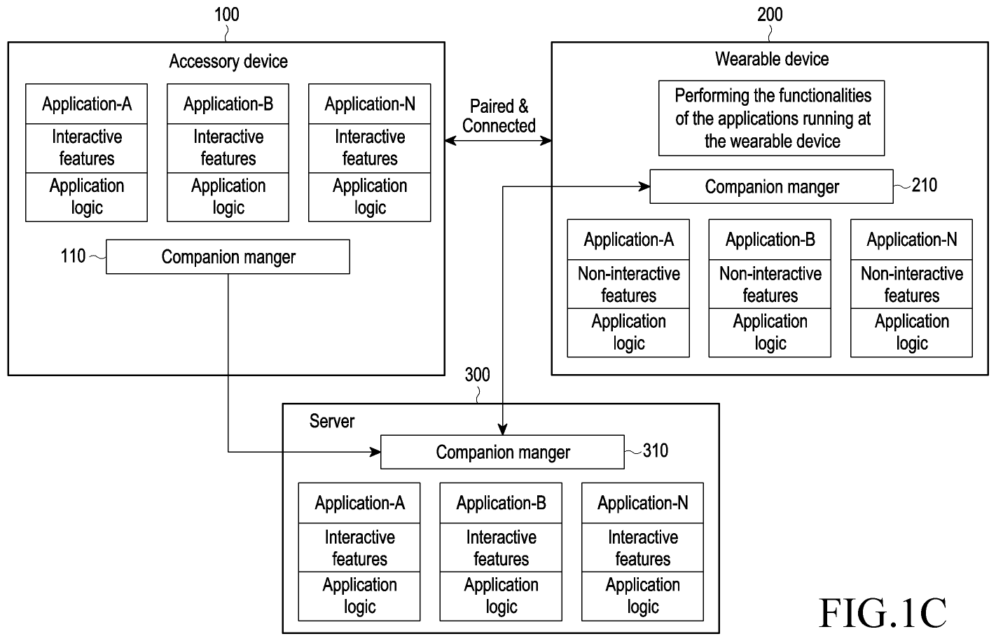

Referring now to the drawings, and more particularly to FIGS. 1 through 20, where similar reference characters denote corresponding features consistently throughout the figures, there are shown preferred embodiments.

FIG. 1B is an example scenario in which a companion mode application calling scenario between an accessory device 100 and a companion device 200 is detailed, according to an embodiment as disclosed herein.

Unlike the conventional method and system (as detailed in the FIG. 1A), the present invention provides a companion manager 110 at the accessory device 100. The companion manager 110 (hereinafter “CM 110”) can be configured to identify at least one first feature of one or more applications (applications A, B . . . N) managed by the application manager (not shown) of the accessory device 100.

the at least one non-interactive(non-user triggering dependent feature) feature of one or more applications (applications A, B . . . N) managed by the application manager (not shown) of the accessory device 100. Further, the CM 110 can be configured to port the at least one non-interactive feature identified, to execute, at the wearable device 200.

Unlike the conventional methods and systems, where application logic is configured to control one or more operations (i.e., invoking, calling, etc.) of the one or more features of the one or more applications running at the accessory device 100. The CM 110, of the present invention, can identify the at least one non-interactive feature of the one or more accessory applications and delegates the at least one non-interactive feature (i.e., task/sub-task to be performed) at the wearable device 200. Thus, whenever a notification corresponding to the at least one non-interactive feature ported to the wearable device 200 is fetched, the companion manager 210 (hereinafter “CM 210”) at the wearable device 200 can invoke/call the at least one operation of the at least one non-interactive feature on behalf of the accessory device 100.

FIG. 1C is an example scenario in which a companion mode application calling scenario between an accessory device, server, and a companion device is detailed, according to another embodiment as disclosed herein.

Consider a scenario, in which the accessory device 100 receives and streams the content of the one or more applications which are available at a server 300. In this scenario, the CM 110 of the present invention can therefore request the server 300 to generate an application package and transfer to the companion device 200.

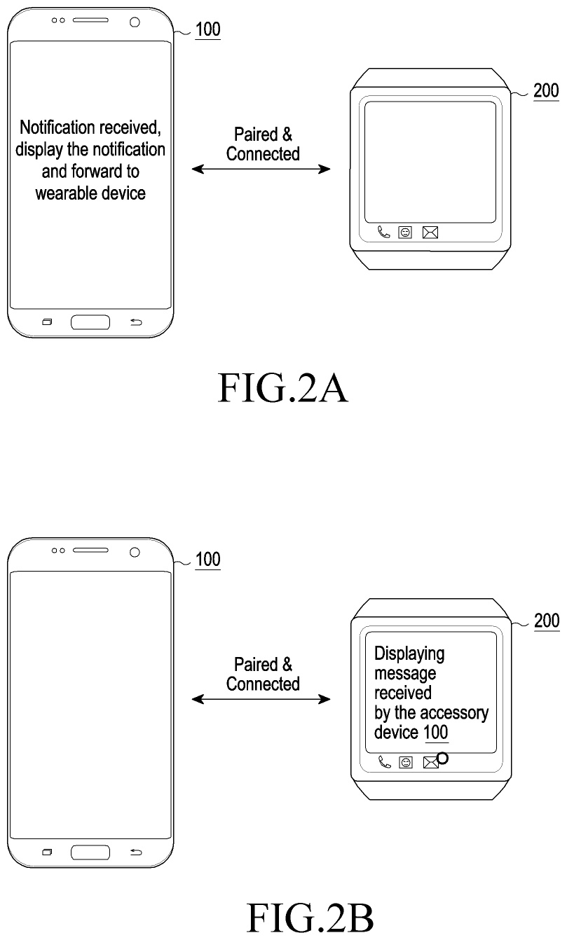

FIG. 2A illustrates another example scenario in which the operations between the smart phone 100 and wearable device 200 are detailed, according to prior art. When the smart phone 100 is connected/paired with the wearable device 200, the notification fetched by the smart phone 100 is forwarded to the wearable device 200. Thus, both the smart phone 100 and the wearable device 200 displays the notification consuming the CPU cycles of each respectively.

FIG. 2B illustrates another example scenario in which the operations between the accessory device 100 and the companion device 200 are detailed, according to an embodiment as disclosed herein.

Unlike the conventional method and system (as detailed in the FIG. 2A), the companion manager 110 of the present invention can be configured to delegate the at least one non-interactive feature of the accessory application to the companion device 200. Thus, the at least operation of the at least one feature is executed by the companion device 200 by utilizing the hardware resources of the companion device 200. Thereby, conserving the CPU cycles and other hardware resources of the accessory device 100.

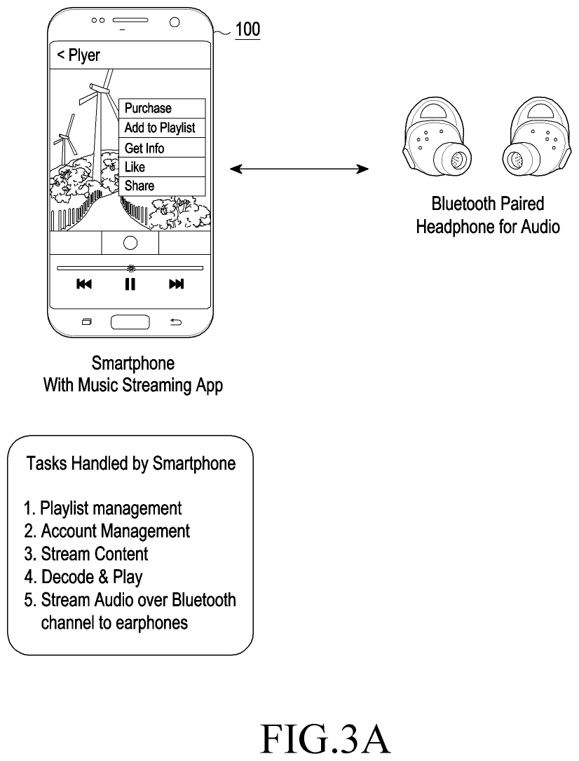

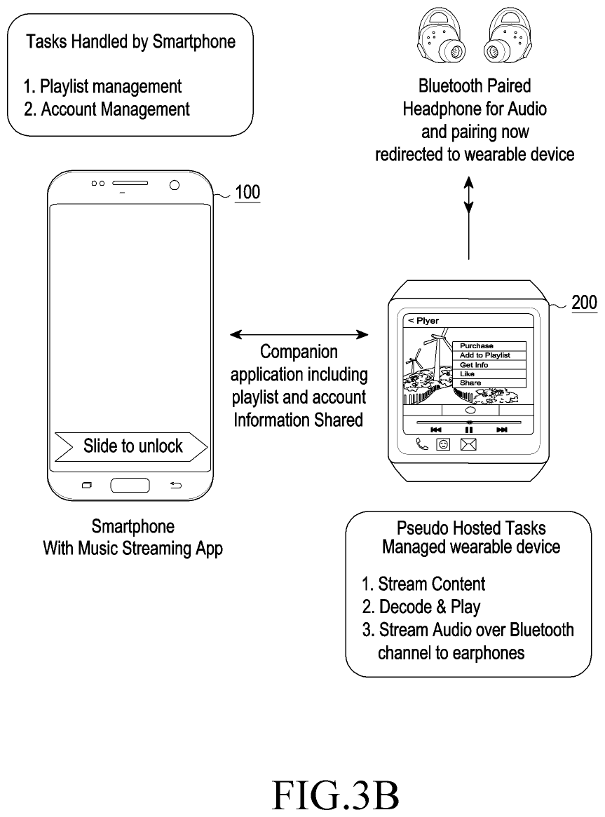

FIG. 3A illustrates an example scenario illustrating a communication between an accessory device and paired audio earphone, according to prior art.

Referring to FIG. 3A, consider a scenario when the accessory device 100 (i.e., smart phone) is connected/paired with an audio earphones through a wireless connectivity (e.g., Bluetooth). When a user of the accessory device 100 streams an audio track from a music application associated with the accessory device 100, the user can therefore be able to listen the audio track through the audio earphones. The one or more tasks managed by the accessory device 100 during the course of streaming the audio track to the audio earphones includes playlist management, account management, stream content (i.e., selecting next audio track, previous audio track, pause the audio track, etc.), decode and play, stream audio over paired Bluetooth channel to the audio earphones. Whenever the accessory device 100 detects a battery low event, the accessory device 100, the user can therefore restrict the running of the music application in order to increase the battery expectancy of the accessory device 100.

FIG. 3B is an example scenario illustrating a communication between an accessory device, paired audio earphone, and a wearable device (i.e., companion device), according to an embodiment as disclosed herein.

Unlike the conventional methods and systems (as detailed in the FIG. 3A), the proposed method and system may allow the accessory device 100 to delegate at least one feature of one or more applications running at the accessory device 100 to the companion device 200, as illustrated in the FIG. 3B. Referring to the FIG. 3B, the accessory device 100 streaming the audio track to the paired audio earphones from the music application running at the accessory device 100 may therefore delegate the at least one feature of the music application which involves very limited user interaction i.e., only next previous, volume up down interactions, can be ported, by the accessory device 100, to execute at the wearable device 200. The features such as i.e., stream content (i.e., selecting next audio track, previous audio track, pause the audio track, etc.), decode and play, stream audio over paired Bluetooth channel to the audio earphones can be executed through the wearable device 200. Thus, considerable pairing, streaming, decoding music computations can be delegated to the companion device 200, which conserves the CPU cycles and increases the life expectancy (i.e., battery level, memory, etc.) of the accessory device 100.

Unlike the conventional methods and systems, the proposed companion device 200 can function as peer to the accessory device 100.

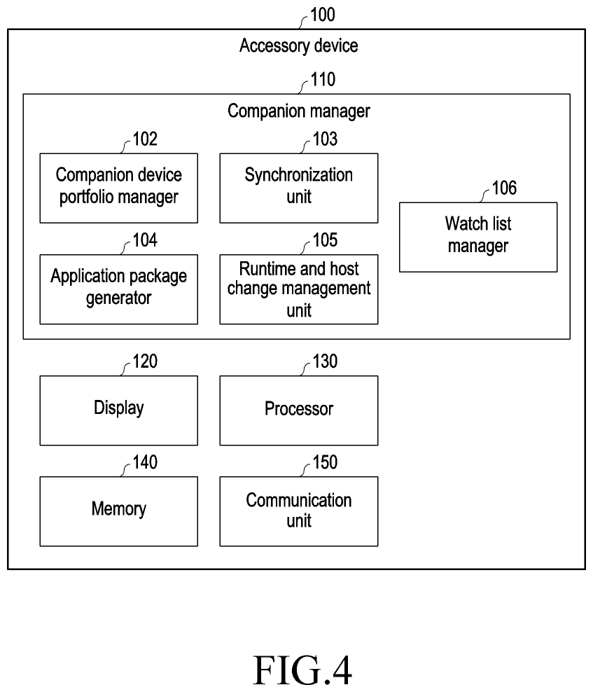

FIG. 4 illustrates various units of the accessory device 100, according to an embodiment as disclosed herein. The accessory device 100 can be, for example, a laptop, a desktop computer, a mobile phone, a smart phone, PDA, a tablet, a phablet, a dual display device, a wearable device for example, a smart watch, a smart bracelet, a smart glass, etc., Internet of things (IoT) devices, or any other consumer electronic device. The accessory device 100 can be, for example, a host device/primary device/master device including the at least one host application running in the host device.

The accessory device 100 may include (or, be associated with) a display 120 (e.g., a Cathode Ray Tube (CRT), a Liquid Crystal Display (LCD), a Light-emitting diode (LED)) being interfaced with the processor 130 (e.g., a hardware unit, an apparatus, a Central Processing Unit (CPU), a Graphics Processing Unit (GPU)), a companion manager 110 (hereinafter “CM” 110); a memory 140, and a communication unit 150.

The display unit 120 can be configured to detect a input performed by a user on an indication of an accessory application displayed on the accessory device 100. The input can be, for e.g., generated by the user gesture (i.e., drag and drop gesture, touch, swipe, pinch, rail, hover, or the like), system generated event (i.e., low battery event), and event generated notification. The indication can be, for e.g., graphical element, graphical icon, or the like. The application can be, for example, a Message application, a Social Networking Site (SNS) application, an E-Mail application, a Gallery application, a Call application, or any other application available in the accessory device 100.

The CM 110 can be configured to enable a companion mode for the accessory application based on the input, wherein the companion mode provides an application package comprising at least one component of the at least one non-interactive feature of the accessory application. The at least one component can include, for example, at least one library instruction and interface instruction of the at least one non-interactive feature. The at least one component can be received from a source provider of the accessory application/can be created by the CM 110.

Once the CM 110 detects the accessory application is in the companion mode (i.e., the companion mode is enabled for the accessory application), the CM 110 can therefore identify the at least one non-interactive feature of the accessory application. In general the accessory application may include three types of features such as interactive feature, the non-interactive feature, and a bounded feature. The interactive feature is the feature which are dependent on the views of the user; triggered by the user interaction and run as per the user navigation e.g., SNS message sending feature. The non-interactive features are the features which are not dependent on triggering by the user interaction and can run without view bounded process. Examples of the non-interactive feature includes notification listening in the accessory application, background update checking and processing, syncing the data to the online servers (e.g., cloud, drives), etc. The bounded feature are the feature including both the feature of the interactive and non-interactive i.e., triggered by the user interaction & run in background but view process waits for result e.g., file downloading feature.

Unlike the conventional systems and methods, the proposed methods and system can assist, by way of the CM 110, the user to run the at least one non-interactive feature of the accessory device 100 on the companion device 200 thus conserving the processor 130 cycle of the accessory device 100.

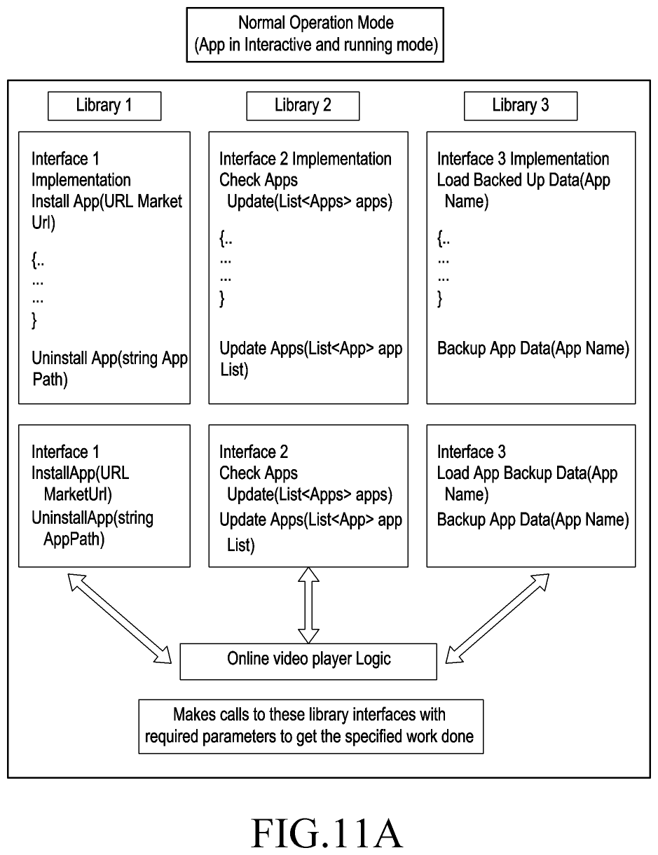

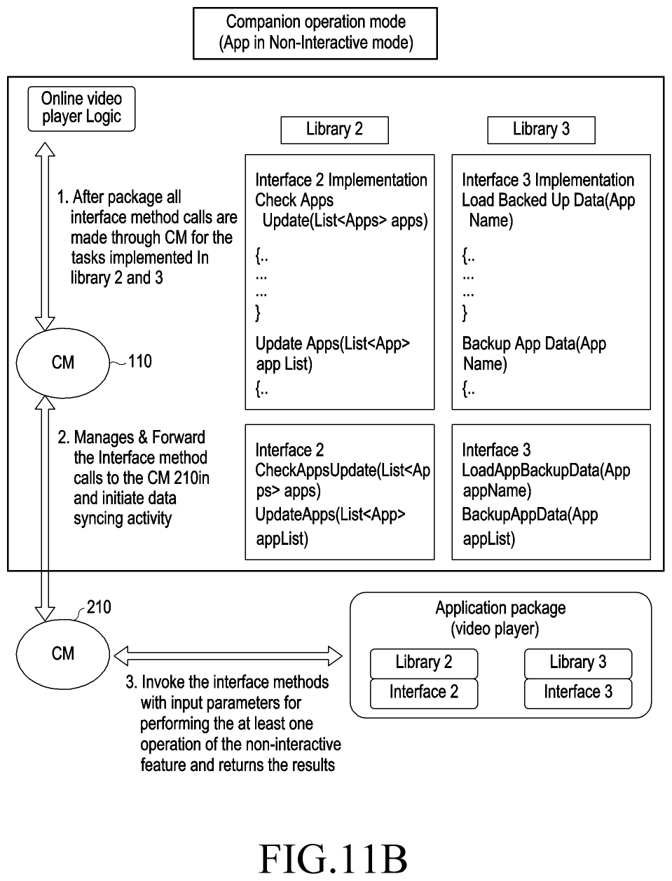

Further, the CM 110 can be configured to generate an application package (as detailed in FIG. 11B) comprising at least one component of the at least one non-interactive feature of the accessory application. The at least one component may include, for e.g., one or more libraries provided by the application vendor. The one or more libraries may constitute the application logic configured to control the one or more operations of the at least one feature. Further, the CM 110 can be configured to transfer the application package to the companion device 200 to perform at least one operation corresponding to the at least one non-interactive feature of the accessory application at the companion device on behalf of the accessory device 100. The at least one component of the at least one non-interactive feature provides a companion application to perform the at least one operation corresponding to the at least one non-interactive feature of the accessory application. The companion application can be executed by the companion device 200.

In another embodiment, the CM 110 can be configured to send a request to a server, the request includes, for e.g., to generate the application package by the server and transfer the application package generated to the companion device 200.

Further, the CM 110 includes a companion device portfolio manager 102, a synchronization unit 103, an application package generator 104, a runtime and host change manager 105, and a watch list manager 106. The companion device portfolio manager 102 can be configured to measure the capabilities [constant “C”] of the companion device 200 based on a plurality of parameters, which decides which of the electronic device(s) connected/paired to the accessory device 100 can be the companion to the accessory device 100. The plurality of parameters such as, for e.g., battery level(s) [F(x)] (factor of learnt usage pattern with battery statistics) of the electronic device(s) connected/paired to the accessory device 100, resource availability [g(y)] (Current CPU usage, memory utilization etc.) of the electronic device(s) connected/paired to the accessory device 100, etc. The companion device portfolio manager 102 can be configured to compute a qualification index [Q] by using below equation (1).

Q=f(x)+g(y)+C (1)

The synchronization unit 103 may be associated with the CM 110 and the CM 210 running separately on both the accessory device 100 and the companion device 200 and perform the tasks of feature host change, runtime environment change, session and identity replication, remote method invocation, companion device 200/accessory device 100 portfolio management, stub requirements factors, etc. The synchronization unit 103 can be configured to send the information about the at least one operation corresponding to the at least one non-interactive features of the accessory application performed at the companion device 200 based on the synchronization event.

The application package generator 104 can be configured to generate the application package including the at least one component of the non-interactive feature.

The runtime and host change manager 105 can be configured to manage the at least one application running on the accessory device 100 that includes both the interactive and non-interactive features. (i.e., includes all the feature set provided by the application provider(s)). In another embodiment, a stub (i.e., companion application) of the runtime and host change manager 105 can run on the companion device 200 and may include a dedicated logic instructions to perform very limited tasks. The runtime and host change manager 105 at the companion device 200 may include the subset of features from the accessory application feature set.

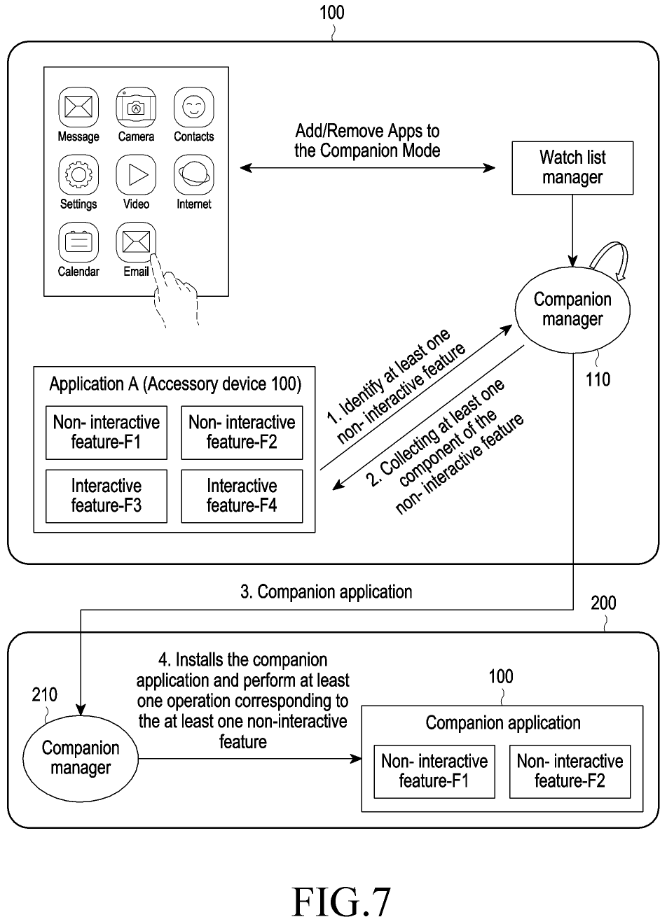

The watch list manager 106 can be configured to maintain a list of applications added by the user (i.e., enabling the companion mode). The accessory device 100 detects the gesture performed by the user towards the one or more applications in order to associate/de-associate from the watch list manager 106, as detailed in FIG. 7.

The memory 140 may include a non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 150 may, in some examples, be considered a non-transitory storage medium. The term “non-transitory” may indicate that the storage medium is not embodied in a carrier wave or a propagated signal. However, the term “non-transitory” should not be interpreted that the memory 150 is non-movable. In some examples, the memory 150 can be configured to store larger amounts of information than the memory. In certain examples, a non-transitory storage medium may store data that can, over time, change (e.g., in Random Access Memory (RAM) or cache). The communication unit 150 communicates internally with the units and externally with networks.

The FIG. 4 shows a limited overview of the accessory device 100 but, it is to be understood that another embodiment is not limited thereto. Further, the accessory device 100 can include different units communicating among each other along with other hardware or software components. By way of illustration, both an application running on the accessory device 100 and the accessory device 100 can be the component.

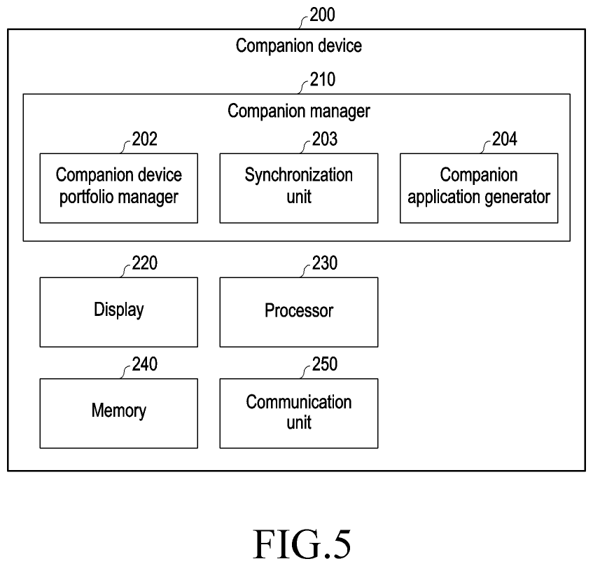

FIG. 5 illustrates various units of the companion device 200, according to an embodiment as disclosed herein. The companion device 200 can be, for example, a laptop, a desktop computer, a mobile phone, a smart phone, PDA, a tablet, a phablet, a dual display device, a wearable device for example, a smart watch, a smart bracelet, a smart glass, etc., Internet of things (IoT) devices, or any other consumer electronic device. The companion device 200 can be, for example, a host device/primary device/master device including the at least one host application running in the host device.

The companion device 200 may include (or, be associated with) a display 220 (e.g., a Cathode Ray Tube (CRT), a Liquid Crystal Display (LCD), a Light-emitting diode (LED)) being interfaced with the processor 230 (e.g., a hardware unit, an apparatus, a Central Processing Unit (CPU), a Graphics Processing Unit (GPU)), the CM 210; a memory 240, and a communication unit 250.

The CM 210 can be configured to receive a notification intended for the accessory application at the accessory device 100. Further, the CM 210 can be configured to determine whether the notification corresponds to the at least one non-interactive feature of the accessory application and perform at least one operation corresponding to the at least one non-interactive feature of the accessory application using the companion application at the companion device 200 on behalf of the accessory device 100. The operations can include, for e.g., displaying the notifications, replying to the notification, playing one or more content of the at least one application (i.e., music application from accessing from the online server), etc. The companion device 200 can be, for e.g., a secondary device capable of performing the one or more operations associated with the application running at the primary electronic device on behalf of the primary electronic device. The primary electronic device and the secondary electronic device connected/paired through a wired/wireless connectivity.

Further, the companion application is created by receiving the application package from the accessory device 100. The application package includes at least one component of the at least one non-interactive feature of the accessory application, wherein the at least one component of the at least one non-interactive feature provides the companion application to perform the at least one operation corresponding to the at least one non-interactive feature of the accessory application. Further, the CM 210 can be configured to create the companion application based on the application package.

Further, the CM 210 includes an accessory device portfolio manager 202, a synchronization unit 203, and a companion application package generator 204. The accessory device portfolio manager 202 can be configured to measure the capabilities [constant “C”] of the accessory device 100 based on a plurality of parameters, which decides which of the electronic device(s) connected/paired to the companion device 200 can be the accessory device 100. The plurality of parameters such as, for e.g., battery level(s) [F(x)] (factor of learnt usage pattern with battery statistics) of the electronic device(s) connected/paired to the companion device 200, resource availability [g(y)] (Current CPU usage, memory utilization etc.) of the electronic device(s) connected/paired to the companion device 200, etc. The accessory device portfolio manager 202 can be configured to compute a qualification index [Q] by using below equation (2).

Q=f(x)+g(y)+C (2)

The synchronization unit 103 may be associated with the CM 110 and the CM 210 running separately on both the accessory device 100 and the companion device 200 and perform the tasks of feature host change, runtime environment change, session and identity replication, remote method invocation, companion device 200/accessory device 100 portfolio management, stub requirements factors, etc. The synchronization unit 203 can be configured to send the information about the at least one operation corresponding to the at least one non-interactive features of the accessory application hosted at the accessory device 200/the server 300 based on the synchronization event.

The companion application generator 204 can be configured to generate the companion application including the at least one component of the at least one non-interactive feature.

FIG. 5 shows a limited overview of the companion device 200 but, it is to be understood that another embodiment is not limited thereto. Further, the companion device 200 can include different units communicating among each other along with other hardware or software components. By way of illustration, both an application running on the companion device 200 and the companion device 200 can be the component.

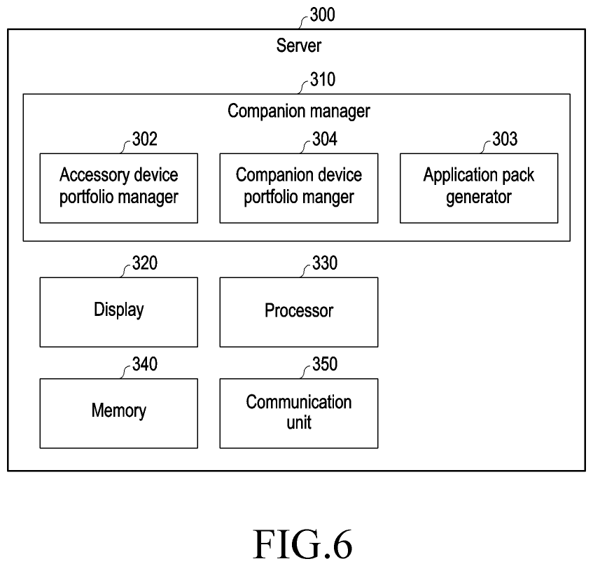

FIG. 6 illustrates various units of the server 300, according to an embodiment as disclosed herein. The server 300 can be, for example, a laptop, a desktop computer, a mobile phone, a smart phone, PDA, a tablet, a phablet, a dual display device, a wearable device for example, a smart watch, a smart bracelet, a smart glass, etc., Internet of things (IoT) devices, or any other consumer electronic device.

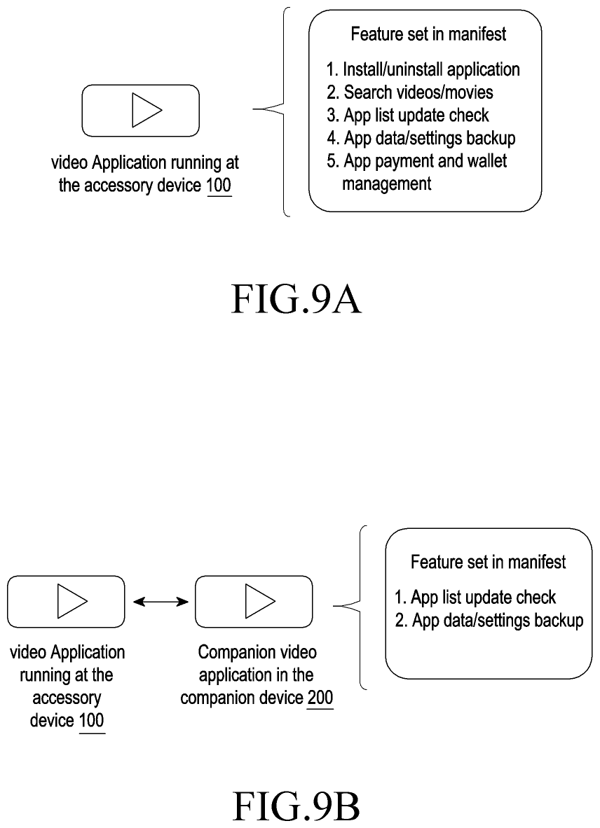

Referring to the FIG. 9, the server 300 includes a companion manager 310 (“CM 310”), a processor 330 (e.g., a hardware unit, an apparatus, a Central Processing Unit (CPU), a Graphics Processing Unit (GPU)), a display 320, a memory 340 and a communication unit 350.

The CM 310 can be configured to identify the at least one non-interactive feature of the accessory application running at the accessory device 100. Further, the CM 310 can be configured to generate the application package comprising the at least one component of the at least one non-interactive feature of the accessory application. Furthermore, the CM 310 can be configured to transfer the application package to the companion device 200 to perform the at least one operation corresponding to the at least one non-interactive feature of the accessory application at the companion device 200 on behalf of the accessory device 100.

The companion device 200 can be selected based on a qualification index computed by the server 300. The qualification index is dynamically updated based on a plurality of parameters associated with the companion device 200. The plurality of parameters can include, for e.g., at least one of a synchronization event, a storage capacity, device capability, battery level, and resources availability. The device capabilities includes, for e.g., sensors capabilities, RAM capacity, etc. The resources availability can include, for e.g., current processor 330 usage, memory utilization, etc.

The memory 340 may include a non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 340 may, in some examples, be considered a non-transitory storage medium. The term “non-transitory” may indicate that the storage medium is not embodied in a carrier wave or a propagated signal. However, the term “non-transitory” should not be interpreted that the memory 340 is non-movable. In some examples, the memory 340 can be configured to store larger amounts of information than the memory. In certain examples, a non-transitory storage medium may store data that can, over time, change (e.g., in Random Access Memory (RAM) or cache). The communication unit 350 communicates internally with the units and externally with networks.

The CM 310 includes an accessory device portfolio manager 302 configured to compute the “Q” of the accessory device 100 using the equation (1). The resultant output of the “Q” decides whether to receive the request from the accessory device 100. Further, CM 310 includes a companion device portfolio manager 303 configured to compute the “Q” of the companion device 200 using the equation (2). The resultant output of the “Q” decides whether to transfer the application package to the companion device 100. Furthermore, the CM 310 includes an application package generator 304 configured to generate the application package.

The FIG. 6 shows a limited overview of the server 300 but, it is to be understood that another embodiment is not limited thereto. Further, the server 300 can include different units communicating among each other along with other hardware or software components. By way of illustration, both an application running on the server 300 and the server 300 can be the component.

The accessory device 100, the companion device 200, and the server 300 can be combined to form an overall system (not depicted) for managing the accessory application. The functionalities of the accessory device 100, the companion device 200, and the server 300 are detailed in conjunction with the FIGS. 4-6.

FIG. 7 illustrates an architecture for managing the accessory application of the accessory device 100 by the companion device 200, according to an embodiment as disclosed herein.

Referring to the FIG. 7, the accessory device 100 detects the gesture performed by the user to add the at least one accessory application (e.g., E-mail application) of the accessory device 100 into the companion mode. The at least one accessory application added into the companion mode is maintained in the watch list manager 106 and includes the feature set manifest of the at least one accessory application. The watch list manager 106 communicates information of the at least one accessory application presented therein to the CM 110. The CM 110 can be configured to identify the one or more non-interactive feature of the at least one accessory application. Further, the CM 110 can be configured to collect the at least one component (i.e., libraries list) of the one or more non-interactive feature and thereafter generates the application package including the at least one component collected.

Once the application package is created, the CM 110 can be configured to transfer the application package to the companion device 200. The CM 210 receives the application package (includes the stubs of the one or more non-interactive features of the at least one accessory application running at the accessory device 100). Thus, the operations corresponding to the one or more non-interactive feature are performed by the companion device 200 on behalf of the accessory device 100.

In another embodiment, when the at least component of the accessory application is unavailable, then the CM 110 may request the server 300 to generate the application package including the at least one component and transfer the application package to the CM 210 of the companion device 200.

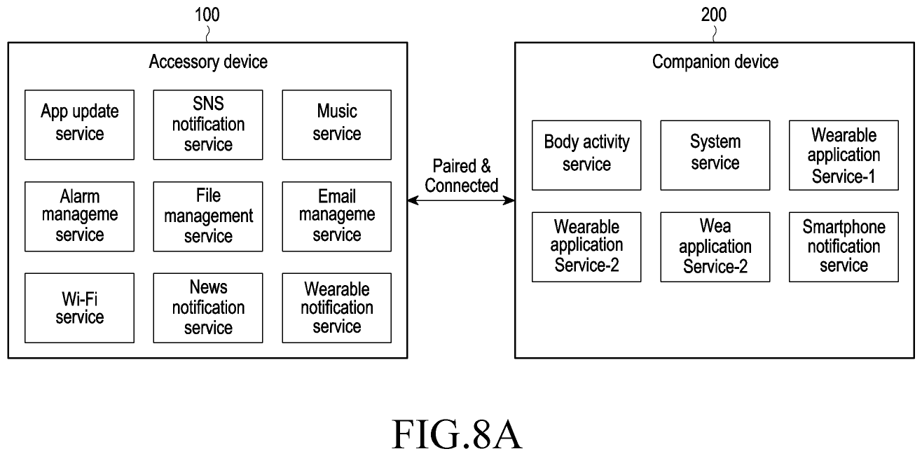

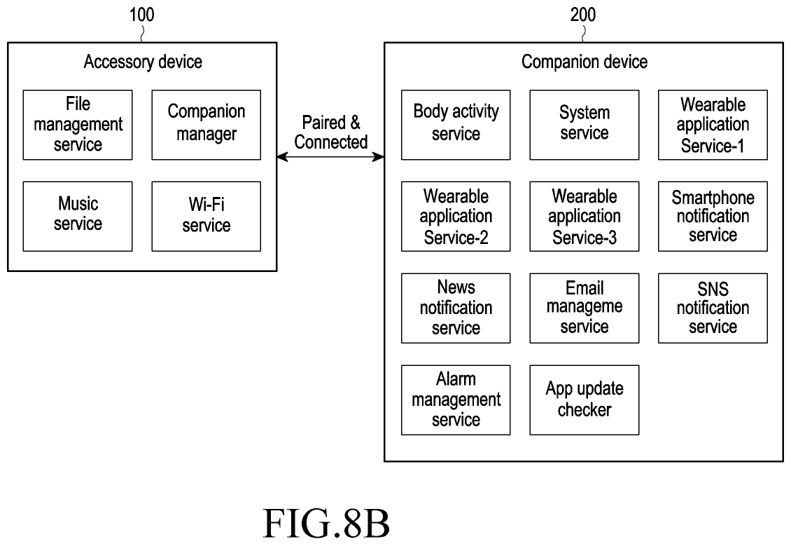

FIG. 8A illustrates a state of a processor for managing the one or more accessory applications of the accessory device 100, according to prior art. Consider, the user of the accessory device 100 launches the one or more accessory applications and interacts with each of the application in sequential respectively. Once, after each interaction with each of the accessory application, the user may continue the service(s) of the one or more accessory applications and thus maintains running of the one or more accessory applications at the background (instead of terminating). The services of the one or more accessory applications managed by the processor at the background are, for e.g., App update service, SNS notification service, Music service, Alarm management service, File management service, Email management service, Wi-Fi service, News notification service, Wearable notification service, etc. All the services of the applications consumes the processor cycle and thereto affect the performance (i.e., memory, battery, etc.) of the accessory device 100.

Similarly, the services managed by a processor of the wearable device 200 can include, for e.g., Body activity service, System service, Wearable application Services-1-3, Smartphone notification service, etc., as shown in FIG. 8A

Unlike to the conventional methods and systems (as detailed in the FIG. 8A), the CM 110 of the accessory device 100 can be configured to delegate the services of the at least one-non interactive features to the companion device 200. The services such as i.e., App update service, SNS notification service, Alarm management service, Email management service, News notification service, Wearable notification service are now managed by the processor 230 of the companion device 200, as shown in FIG. 8B. Thus, conserving the cycle of the processor 140.

FIG. 9A illustrates an example scenario in which the accessory device 100 is configured to manage one or more features of a video player application running at the accessory device 100, according to prior art.

In general, the one or more features of the video player application utilized by the user during the interaction with the video player application includes, for e.g., Install/uninstall application, Search videos/movies, App list update check, App data/settings backup, App payment and wallet management, etc. The processor of the accessory device receives one or more instructions in order to perform the one or more operations concerning to the aforementioned one or more features of the video player application.

Unlike to the conventional methods and systems (as detailed in FIG. 9A) the user, by way of the proposed methods and systems, can therefore enable the companion mode to the video player application by adding the video player application into the watch list manager 106. The CM 110 can therefore identify the at least one-non interactive feature from the one or more features of the video player application, generate the application including the at least one component (e.g., libraries) of the at least one non-interactive feature and transfer the application package to the companion device 200. The at least one-non interactive feature of the video player application can include, for e.g., App list update check, App data/settings backup. Thus, the operations concerning to the at least one non interactive feature are performed by the processor 230 of the companion device 200 on behalf of the accessory device 100, as shown in FIG. 9B.

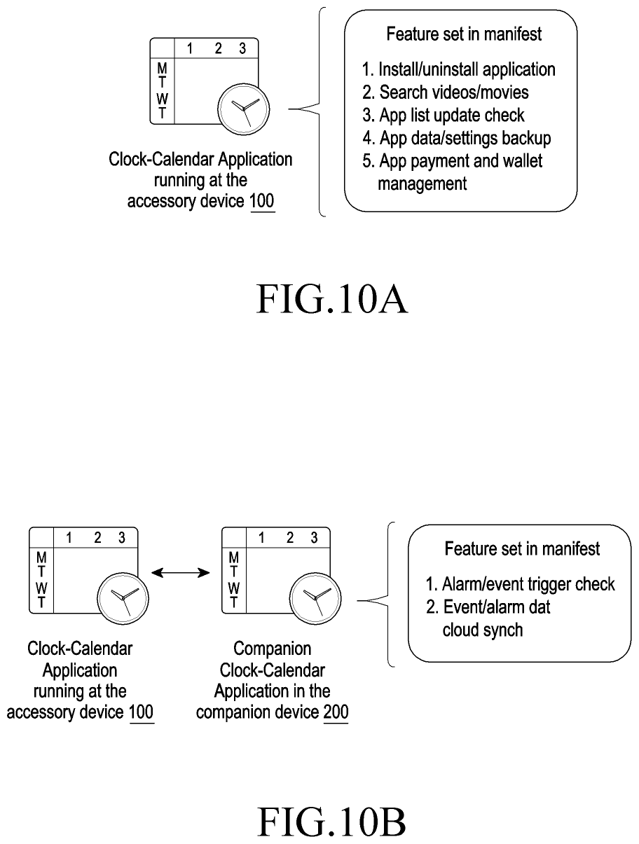

FIG. 10A illustrates an example scenario in which the accessory device 100 is configured to manage one or more features of a clock calendar application running at the accessory device 100, according to prior art.

In general, the one or more features of the clock calendar application utilized by the user during the course of interaction with the clock calendar application includes, for e.g., Create alarm/event management, Update alarm/event schedule, Delete alarm/event schedule, Alarm/event trigger check, Event/alarm data cloud synch, etc. The processor of the accessory device receives one or more instructions in order to perform the one or more operations concerning to the aforementioned one or more features of the clock calendar application.

Unlike to the conventional methods and systems (as detailed in the FIG. 10A) the user, by way of the proposed methods and systems, can therefore enable the companion mode to the clock calendar application by adding the clock calendar application into the watch list manager 106. The CM 110 can therefore identify the at least one-non interactive feature from the one or more features of the clock calendar application, generate the application including the at least one component (e.g., libraries) of the at least one non-interactive feature (as detailed in conjunction with FIG. 11B) and transfer the application package to the companion device 200. The at least one-non interactive feature of the clock calendar application can include, for e.g., alarm/event trigger check and Event/alarm data cloud synch. Thus, the operations concerning to the at least one non interactive feature are performed by the processor 230 of the companion device 200, as shown in the FIG. 10B.

FIG. 11A illustrates an example scenario in which normal operation mode of the at least one feature of the at least one application running at the accessory device 100 is disclosed, according to prior art.

Referring to the FIG. 11A, the at least one feature of the at least one application may include the at least one component e.g., one or more libraries (e.g., libraries—1, 2, and 3) and interface (e.g., Interfaces—1, 2, and 3) associated therewith. The at least one feature of the accessory application may include, for e.g., install/uninstall, check app update, application backup, etc. whenever the application logic calls the one or more features of the at least one accessory application these libraries and interface associated therewith are triggered, by the application logic, with required parameters in order to perform the respective operations.

Unlike the conventional methods and systems (as detailed in the FIG. 11A), the CM 110 of the present invention can be configured to port the at least one non-interactive feature of the accessory application to the companion device 200. Thus, the companion device 200 can be configured to perform the at least one operation of the at least one feature of the accessory application on behalf of the accessory device 100, as illustrated in FIG. 11B.

Referring to the FIG. 11B, the libraries and interface(s) of the at least one feature (e.g., non-interactive) of the at least one accessory application is packaged (i.e., application package). Once the application package is generated all interface method calls are triggered through the CM 110. Further, the CM 110 manages and forwards the interface method calls to the CM 210 and initiates data syncing activity (via synchronization unit 203). Furthermore, the CM 210 can be configured to invoke the interface method with one or more parameters (input provided by the user) for performing the at least one operation of the non-interactive feature and returns the results (at the companion device 200).

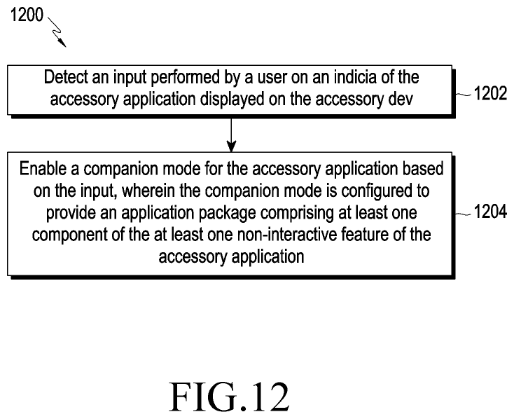

FIG. 12 is a flow diagram 1200 illustrating a method for managing the accessory application of the accessory device 100, according to an embodiment as disclosed herein.

Referring to the FIG. 12, in step 1202, the accessory device 100 detects the input (e.g., gesture) performed by the user on the indication of the accessory application displayed on the accessory device 100. For example, in the accessory device 100, as illustrated in the FIG. 4, the CM 110 is configured to detect the gesture performed by the user on the indication of the accessory application displayed on the accessory device 100.

In step 1204, the accessory device 100 enables the companion mode for the accessory application based on the input, wherein the companion mode is configured to provide the application package comprising at least one component of the at least one non-interactive feature of the accessory application. For example, in the accessory device 100, as illustrated in the FIG. 4, the CM 110 is configured to enable the companion mode for the accessory application based on the input, wherein the companion mode is configured to provide the application package comprising at least one component of the at least one non-interactive feature of the accessory application.

The various actions, acts, blocks, steps, or the like in the flow chart 1200 may be performed in the order presented, in a different order or simultaneously. Further, in some embodiments, some of the actions, acts, blocks, steps, or the like may be omitted, added, modified, skipped, or the like without departing from the scope of the invention.

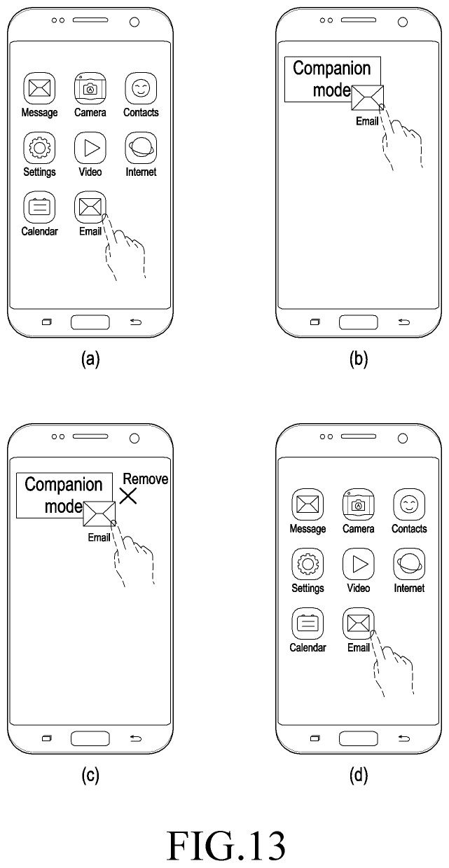

FIG. 13 illustrates an example scenario in which the user of the accessory device 100 associates and de-associates the at least one accessory application from the companion mode, according to an embodiment as disclosed herein.

Referring to the FIG. 13, at first (a) the CM 110 detects the input on the display 120; the input to select the at least one accessory application (as shown in the FIG. 13(a)). Further, the CM 110 detects the gesture input to associate the selected accessory application into the companion mode (as shown in the FIG. 13(b)). Once the CM 110 detects that the companion mode is enabled for the accessory application, then the CM 110 can be configured to generate the application package including the at least one component of the accessory application, and transfer the application package to the CM 210 of the companion device 200. Further, the CM 110 detects the input to de-associate (i.e., remove/disable) the accessory application from the companion mode (as shown in 13(c)). Once the accessory application is removed from the companion mode the accessory application can placed back into the display portion of the display unit 120 (as show in 13(d)).

Thus, the user can mark the applications from the launcher screen only, whether to allow that application to be watched for the companion mode service and feature hosting change/port.

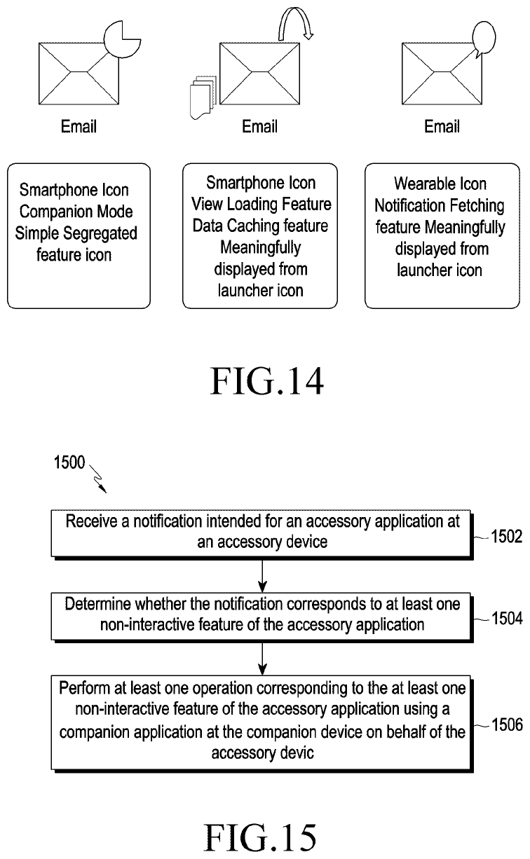

FIG. 14 is an example in which an indication of the accessory application is modified, according to an embodiment as disclosed herein.

Referring to the FIG. 14, when the companion mode for the accessory application is enabled, by fragmenting the at least one feature of the accessory application, the indication of the accessory application is modified accordingly. The modified indication of the accessory application indicates running of the accessory application on the companion device 200. For example, the indication of the E-mail application on the accessory device 100 whose notification feature now is hosted on the companion device 200 may have a changed launcher icon on the all application list. Similarly the companion device 200 may also have the icon with meaningful image as icon for the current running feature of the host.

FIG. 15 is another flow diagram 1500 illustrating a method for managing the accessory application of the accessory device 100 by the companion device 200, according to an embodiment as disclosed herein.

Referring to the FIG. 15, in step 1502, the companion device 200 receives the notification intended for the accessory application at the accessory device 100. For example, in the companion device 200, as illustrated in the FIG. 5, the CM 210 is configured to receive the notification intended for the accessory application at the accessory device 100.

In step 1504, the companion device 200 determines whether the notification corresponds to the at least one non-interactive feature of the accessory application. For example, in the companion device 200, as illustrated in the FIG. 5, the CM 210 is configured to determine whether the notification corresponds to the at least one non-interactive feature of the accessory application.

In step 1506, the companion device 200 performs the at least one operation corresponding to the at least one non-interactive feature of the accessory application using the companion application on behalf of the accessory device 100. For example, in the companion device 200, as illustrated in the FIG. 5, the CM 210 is configured to perform the at least one operation corresponding to the at least one non-interactive feature of the accessory application using the companion application on behalf of the accessory device 100.

The various actions, acts, blocks, steps, or the like in the flow chart 1500 may be performed in the order presented, in a different order or simultaneously. Further, in some embodiments, some of the actions, acts, blocks, steps, or the like may be omitted, added, modified, skipped, or the like without departing from the scope of the invention.

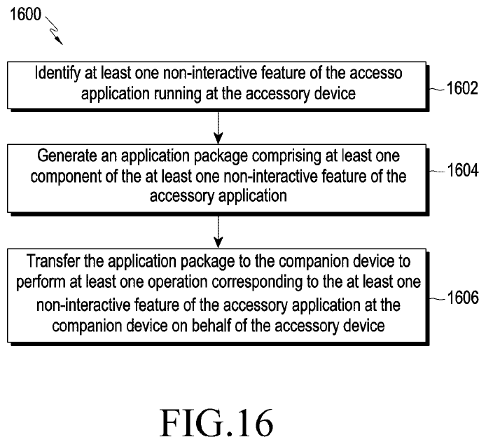

FIG. 16 is a flow diagram 1600 illustrating a method for managing the accessory application of the accessory device 100 by the server 300, according to an embodiment as disclosed herein.

Referring to the FIG. 16, in step 1602, the server 300 identifies the at least one non-interactive feature of the accessory application running at the accessory device 100. For example, in the sever 300, as illustrated in the FIG. 6, the CM 310 is configured to identify the at least one non-interactive feature of the accessory application running at the accessory device 100.

In step 1604, the server 300 generates the application package comprising the at least one component of the at least one non-interactive feature of the accessory application. For example, in the sever 300, as illustrated in the FIG. 6, the CM 310 is configured to generate the application package comprising the at least one component of the at least one non-interactive feature of the accessory application.

In step 1606, the server 300 transfers the application package to the companion device 200 to perform the at least one operation corresponding to the at least one non-interactive feature of the accessory application at the companion device 200 on behalf of the accessory device 100. For example, in the sever 300, as illustrated in the FIG. 6, the CM 310 is configured to transfer the application package to the companion device 200 to perform the at least one operation corresponding to the at least one non-interactive feature of the accessory application at the companion device 200 on behalf of the accessory device 100.

The various actions, acts, blocks, steps, or the like in the flow chart 1600 may be performed in the order presented, in a different order or simultaneously. Further, in some embodiments, some of the actions, acts, blocks, steps, or the like may be omitted, added, modified, skipped, or the like without departing from the scope of the invention.

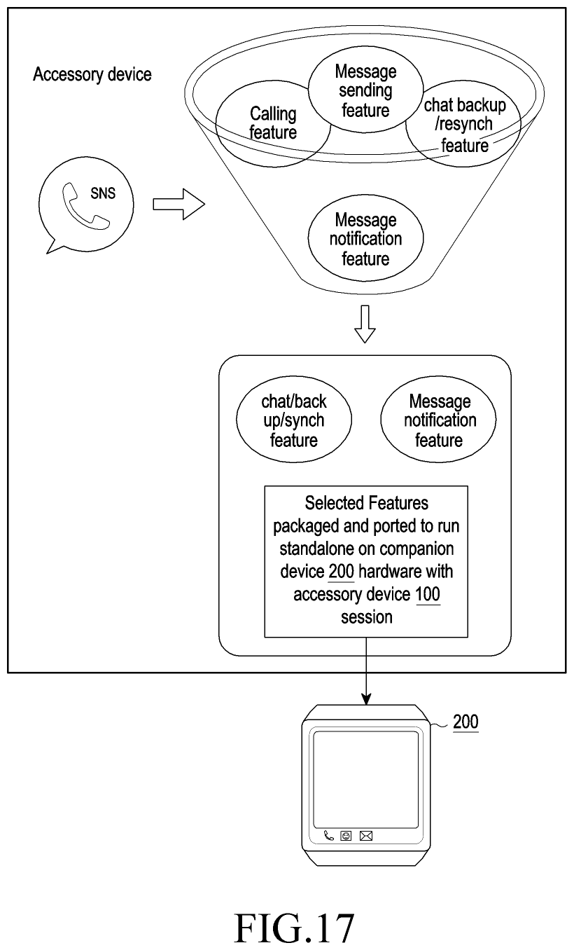

FIG. 17 illustrates an example scenario in which the at least one operation of the non-interactive of the accessory application (i.e., SNS application) is managed by the companion device 200, according to an embodiment as disclosed herein.

Referring to the FIG. 17, the CM 110 is configured to filter the one or more features of a SNS application (provided that the companion mode is enabled to the SNS application). The one or more features includes, for e.g., interactive features such as message sending feature, calling feature and further the non-interactive features such as, for e.g., chat back-up/synch features, and message notification update feature. The CM 110, in response to filtering of the features, fetches the non-interactive features and thereafter ports these non-interactive feature to the companion device 200 by: generating the application package including the at least component of the at least one non-interactive features, and transferring the application package to the companion device 200.

The companion device 200 receives the application package and thereafter is configured to perform the at least one operation corresponding to the at least one non-interactive feature on behalf of the accessory device 100.

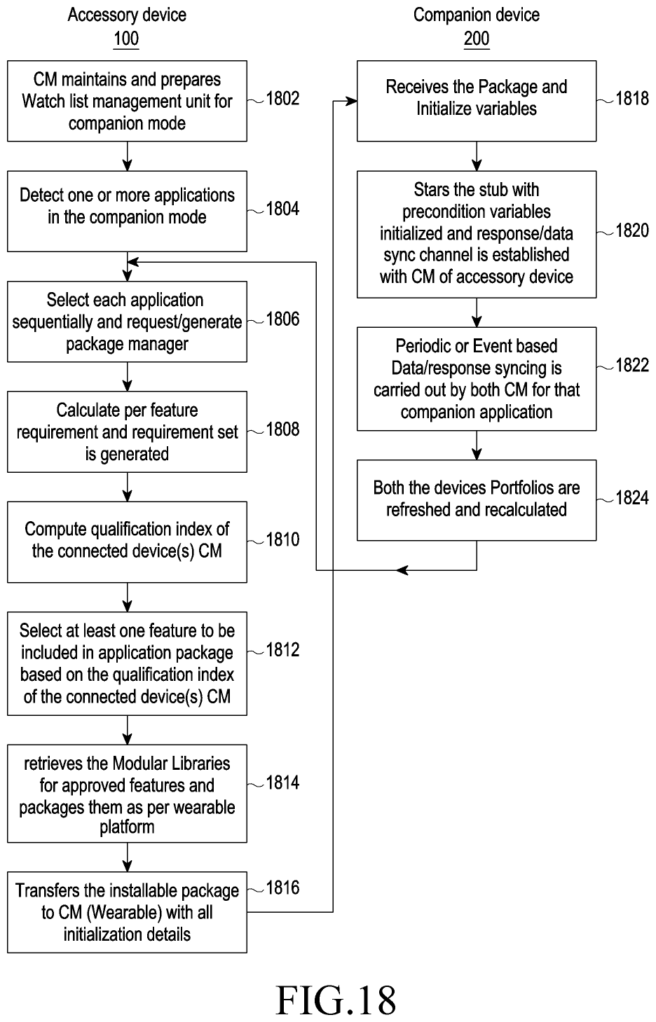

FIG. 18 is a flow diagram 1800 illustrating a complete process flow between the accessory device 100 and the companion device 200 for managing the accessory application, according to an embodiment as disclosed herein.

Referring to the FIG. 18, in step 1802, the CM 110 maintains and prepares watch list manger manger 106 for companion mode. For example, in the accessory device 100, as illustrated in the FIG. 4, the CM 110 is configured to maintain and prepare watch list manager 106 for the companion mode.

In step 1804, the CM 110 detects one or more applications in the companion mode. For example, in the accessory device 100, as illustrated in the FIG. 4, the CM 110 is configured to detect one or more applications in the companion mode.

In step 1806, the CM 110 selects each application sequentially and request/generate package manager. For example, in the accessory device 100, as illustrated in the FIG. 4, the CM 110 is configured to select each application sequentially and request/generate package manager.

In step 1808, the CM 110 calculates per feature requirement and requirement set is generated. For example, in the accessory device 100, as illustrated in the FIG. 4, the CM 110 is configured to calculate per feature requirement and requirement set is generated.

In step 1810, the CM 110 computes the qualification index (Q) of the connected device(s) CM (e.g., CM 210). For example, in the accessory device 100, as illustrated in the FIG. 4, the CM 110 is configured to computes the qualification index (Q) (i.e., portfolio of the connected devices) of the connected device(s) CM (e.g., CM 210).

In step 1812, the CM 110 selects the at least one feature to be included in application package based on the qualification index of the connected device(s) CM. For example, in the accessory device 100, as illustrated in the FIG. 4, the CM 110 is configured to select the at least one feature to be included in application package based on the qualification index of the connected device(s) CM.

In step 1814, the CM 110 retrieves the at least one component (e.g., modular libraries) for approved features and packages them as per wearable platform. For example, in the accessory device 100, as illustrated in the FIG. 4, the CM 110 is configured to retrieve the at least one component (e.g., modular libraries) for approved features and packages them as per wearable platform.

In step 1816, the CM 110 transfers the application package to CM 210 with all initialization details. For example, in the accessory device 100, as illustrated in the FIG. 4, the CM 110 is configured to transfer the application package to CM 210 with all initialization details.

Further at the companion device 200: In step 1818, the CM 210 retrieves the application package and initialize variables associated therewith. Further, in step 1820, the CM 210 start the companion application with precondition variables initialized and response/data sync channel is established with the CM 110 of the accessory device 100. Further, in step 1822, periodic or event based data/response syncing is carried by both the CM 210 and CM 110 for the at least one accessory applications and associated and the companion application. Furthermore, the portfolio of the both the companion device 200 and the accessory device 100 is refreshed and recalculated.

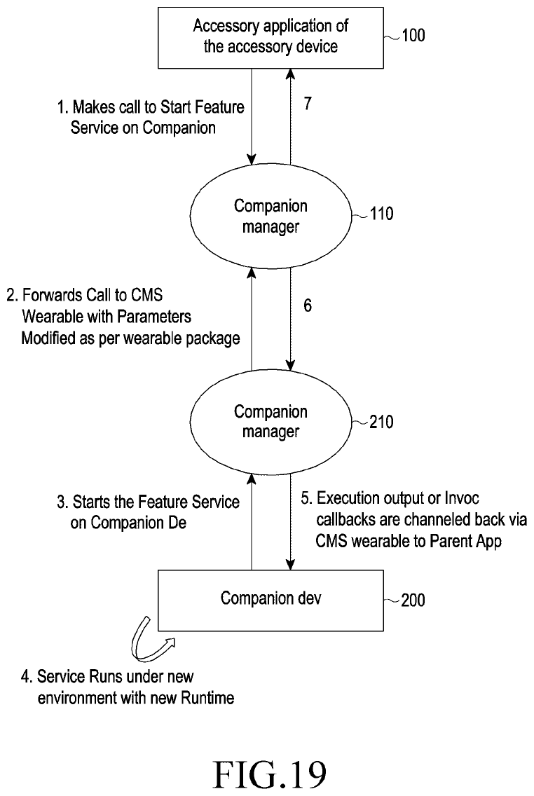

FIG. 19 is a flow diagram 1900 illustrating a post host changing for remote method calls, according to an embodiment as disclosed herein.

Referring to the FIG. 19, at first, the accessory device 100 initiates the call start future service on companion device 200. The CM 110 of the accessory device 100 may fetch these instructions (i.e., call start feature) from the application logic and forwards the call to the CM 210 with parameters modified as per the application package. The CM 210 can be configured to start the feature service on the companion device 200. The companion device 200 can be configured to execute the service under new environment with new runtime. The companion device 200 can be configured to forward the execution output or invocation callbacks are channeled back through the CM 210 to the CM 110.

Related Scenarios:

Unlike to conventional methods and systems, the proposed methods and system may allow the accessory device 100 to provide the stub of the accessory application to the smart television (TV) (paired/connected with the accessory device 100). Thus, whenever the notification (i.e., message) corresponding to the accessory application is fetched by the accessory device 100, the smart TV can therefore display the message and the user can also reply to the message over its own network connectivity, without including the accessory device 100 as middle layer.

For e.g., the one or more accessory applications may be categorized into priority accessory applications and non-priority accessory applications. Both these applications provide their notifications and most of these notifications provides only information/updates and does not involve responding back immediately like news updates, offers and schemes, etc. The proposed methods and system may utilize these non-priority accessory applications, so that the user can effectively port, by way of the proposed method, these non-priority accessory applications in the companion mode and thereafter the notifications related to these non-priority accessory applications can be delegated to be received and displayed on the companion device 200 only.

In another embodiment, the proposed methods and systems are not limited to the non-priority accessory applications/non-interactive features and can even be extended to the priority accessory applications/interactive features.

In general, the user may receive plurality of notifications per day (including instant messaging (IM) notifications, news updates, E-commerce application, music and TV application notifications, etc.). Each of these notifications may consume resources of the accessory device i.e., the resources such as involving audio feedback, haptic feedback, uses display time to display, and processor cycles for processing/receiving them.

Unlike conventional methods and systems, the proposed methods can therefore allow the accessory device 100 to delegate the aforementioned plurality of the notifications to the companion device 200. Thus, effectively conserving the resources (e.g., hardware resource, network, etc.) of the accessory device 100 and utilizing resources of the companion device 200 in order to perform the at least one operation of the at least non-interactive feature of the accessory application.

Since the transferring of the companion application is a onetime process (once done not needed in future), so it is not needed to be performed on daily basis. But the running of applications in the companion mode can be performed daily to affect overall usage by reducing notification processing. For e.g., consider a scenario where the user adds 5-7 applications (i.e., apps such as weather app, E-mail app, SNS app, etc.) during the morning hours (8 AM) to the companion mode with both the accessory device 100 and the companion device 200 at full battery level. The added applications are ported and features are started on the companion device 200 and suspended at the accessory device 100. Thus, when any of these applications produces any notifications they are received by the network connectivity (Wi-Fi, data network, cellular, etc.) of the companion device 200 and only companion device 200 displays the notifications. So the accessory device 100 is not involved in any operations related to these applications (e.g., until these applications are running in the background of the accessory device 100).

In another example, consider a low battery event of the accessory device 100. Once the accessory device 100 detects the low battery event (e.g., battery level 15-20% or any threshold criteria set by the user of the accessory device 100) and the user may not wish to restrict the functioning of the background applications but want to extend the usage time of accessory device 100. Thus, by way of the proposed methods and systems, the accessory device 100 can add/associate most of the running applications into the companion mode and allows running of only critical applications on the accessory device 100. Hence, without stopping the applications to run (unlike power saving mode), the user can leverage the CM 110 functionality i.e. saving battery of the accessory device 100 and running background applications in the companion device 100.

In yet another example, consider the user is travelling which involves a lot of cell handover and network reconnections which is a very battery intensive process. To extend the usage time of the accessory device 100 while travelling the user, by way of the proposed CM 100, moves certain applications in the companion mode. Since the user has moved the apps (i.e., which the user may not be opening very often while travel, but certainly interested in receiving their updates) to the companion mode. The application logic unit 112 may call the CM 110 therefrom the CM 210 to provide the partial functioning experience of these applications (e.g., non-interactive features) along with battery saving feature on the accessory device 100.

Although the embodiments are explained in conjunction with the electronic device and wearable device, but it is to be understood that other embodiments are not limited thereon. The proposed invention can equally be applied to IoT device (i.e., smart TV's) and other home connected devices can also function as Pseudo master to other companion devices. The functionalities of the electronic device can be performed by the IoT device without departing from the scope of the invention.

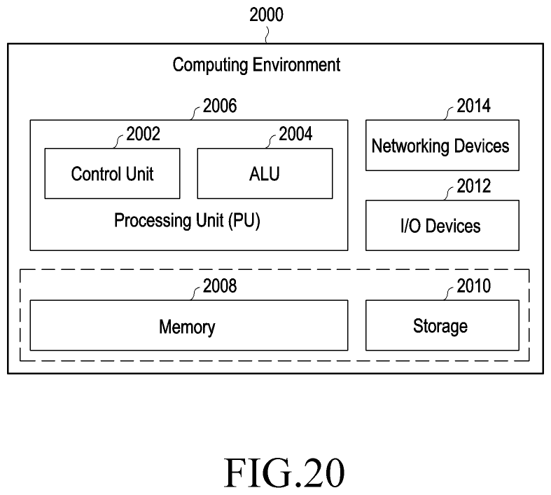

FIG. 20 illustrates a computing environment implementing the method for managing the accessory application, according to an embodiment as disclosed herein. As depicted in the FIG. 20, the computing environment 2000 comprises at least one processing unit 2006 that is equipped with a control unit 2002 and an Arithmetic Logic Unit (ALU) 2004, a memory 2008, a storage unit 2010, plurality of networking devices 2014 and a plurality Input output (I/O) devices 2012. The processing unit 2006 is responsible for processing the instructions of the technique. The processing unit 2006 receives commands from the control unit 2002 in order to perform its processing. Further, any logical and arithmetic operations involved in the execution of the instructions are computed with the help of the ALU 2004.

The overall computing environment 2000 can be composed of multiple homogeneous and/or heterogeneous cores, multiple CPUs of different kinds, special media and other accelerators. The processing unit 2006 is responsible for processing the instructions of the technique. Further, the plurality of processing units 2006 may be located on a single chip or over multiple chips.

The technique comprising of instructions and codes required for the implementation are stored in either the memory unit 2008 or the storage 2010 or both. At the time of execution, the instructions may be fetched from the corresponding memory 2008 or storage 2010, and executed by the processing unit 2008.

In case of any hardware implementations various networking devices 2014 or external I/O devices 2012 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 20 include blocks which can be at least one of a hardware device, or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for managing an accessory application of an accessory device, the method comprising:
receiving, by the accessory device, an input on an indication of an accessory application displayed on an accessory device; and
enabling, by the accessory device, a companion mode for the accessory application based on the input,
wherein the companion mode is configured to provide an application package comprising at least one component of the at least one pre-determined feature of the accessory application.

2. The method of claim 1, wherein the at least one component of the at least one pre-determined feature is configured to provide a companion application to perform at least one operation corresponding to the at least one pre-determined feature of the accessory application.

3. The method of claim 1, wherein the method further comprises:
identifying, by the accessory device, the at least one pre-determined feature of the accessory application running at the accessory device;
generating, by the accessory device, the application package comprising the at least one component of the at least one pre-determined feature of the accessory application; and
transferring, by the accessory device, the application package to a companion device to perform at least one operation corresponding to the at least one pre-determined feature of the accessory application at the companion device on behalf of the accessory device.

4. The method of claim 1, wherein the indication of the accessory application is dynamically modified after adding the accessory application in the companion mode, wherein the modified indication of the accessory application indicates the availability of the accessory application in the companion mode, wherein the companion device is selected by the accessory device based on a qualification index,
wherein the qualification index is dynamically updated based on a plurality of parameters associated with the companion device, wherein the parameters comprises at least one of a synchronization event, a storage capacity, device capability, battery level, and resources availability.

5. The method of claim 1, wherein the accessory device is further configured to receive information about the at least one operation corresponding to the at least one pre-determined features of the accessory application performed on the companion device based on a synchronization event.

6. A method for managing an accessory application of an accessory device by a companion device, the method comprising:
receiving, by the companion device, a notification intended for an accessory application at the accessory device;
determining, by the companion device, whether the notification corresponds to at least one pre-determined feature of the accessory application; and
performing, by the companion device, at least one operation corresponding to the at least one pre-determined feature of the accessory application using a companion application at the companion device on behalf of the accessory device.

7. The method of claim 6, wherein the companion application is created at the companion device by:
receiving an application package comprising at least one component of the at least one pre-determined feature of the accessory application, wherein the at least one components of the at least one pre-determined feature is configured to provide a companion application to perform the at least one operation corresponding to the at least one pre-determined feature of the accessory application; and
creating the companion application based on the application package.

8. The method of claim 6, wherein the method further comprises sending information about the at least one operation, corresponding to the at least one pre-determined features of the accessory application, performed on the companion device based on a synchronization event.

9. A method for managing an accessory application by a server, the method comprising:
identifying, by the server, at least one pre-determined feature of an accessory at application running an accessory device;
generating, by the server, an application package comprising at least one component of the at least one pre-determined feature of the accessory application; and
transferring, by the server, the application package to the companion device to perform at least one operation corresponding to the at least one pre-determined feature of the accessory application at the companion device on behalf of the accessory device.

10. The method of claim 9, wherein the at least one component of the at least one pre-determined feature is configured to provide a companion application to perform at least one operation corresponding to the at least one pre-determined feature of the accessory application.

11. The method of claim 9, wherein identifying the at least one pre-determined feature of the accessory application running at the accessory device comprises:
determining whether a companion mode is enabled for the accessory application; and
identifying the at least one pre-determined feature of the accessory application in response to determining that the accessory application is available in the companion mode.

12. The method of claim 9, wherein the companion device is selected by the accessory device based on a qualification index, and
wherein the qualification index is dynamically updated on a plurality of parameters associated with the companion device, wherein the parameter comprises at least one of a synchronization event, a storage capacity, device capability, battery level, and resources availability.

13. An accessory device comprising:
a memory;
a processor; and
a Companion Manager (CM), coupled to the memory and the processor, configured to:
receive an input on an indication of an accessory application displayed on the accessory device, and
enable a companion mode for the accessory application based on the input,
wherein the companion mode is configured to provide an application package comprising at least one component of the at least one pre-determined feature of the accessory application.

14. A companion device comprising:
a memory;
a processor;
a Companion Manager (CM), coupled to the memory and the processor, configured to:
receive a notification intended for an accessory application at an accessory device;
determine whether the notification corresponds to at least one pre-determined feature of the accessory application; and
perform at least one operation corresponding to the at least one pre-determined feature of the accessory application using a companion application at the companion device on behalf of the accessory device.

15. A server comprising:
a memory;
a processor; and
a Companion Manager (CM), coupled to the memory and the processor, configured to:
identify at least one pre-determined feature of an accessory application running at an accessory device;
generate an application package comprising at least one component of the at least one pre-determined feature of the accessory application; and
transfer the application package to a companion device to perform at least one operation corresponding to the at least one pre-determined feature of the accessory application at the companion device on behalf of the accessory device.
